(19) United States
(12) Patent Application Publication
(10) Pub. No.: US 2010/0031139 A1
(43) Pub. Date: Feb. 4, 2010

(54) NETWORK SYSTEM

(75) Inventor: Yasuhiro Ihara, Yokohama (JP)

Correspondence Address: MORRISON & FOERSTER LLP, 425 MARKET STREET, SAN FRANCISCO, CA, 94105-2482, US

(73) Assignee: ACCESS CO., LTD, Chiyoda-ku, Tokyo (JP)

(21) Appl. No.: 12/521,300

(22) PCT Filed: Dec. 21, 2007
(86) PCT No.: PCT/JP2007/074663

§ 371 Date: Jun. 25, 2009

(30) Foreign Application Priority Data
Dec. 25, 2006 (JP) 20069-347606

(51) Int. Cl. G06F 17/00

(52) U.S. Cl. 715/234; 715/243

(57) ABSTRACT

A network system comprising a terminal device that sends a request for page data for displaying a page to an Web server, an Web server that sends page data in response to the request, and an intermediate processing device that processes the page data received from the Web server and sends the processed page data to the terminal device; wherein the Web server comprises a page data storing means that stores the page data, and the Web server sends the page data corresponding to the request to the intermediate processing device in response to the request from the terminal device; wherein the intermediate processing device comprises a page analyzing means that analyzes the page data received from the Web server, and a layout data generating means that generates layout data to be utilized as a basis for a page layout, based on a result of an analysis by the page analyzing means, and the intermediate processing device sends the generated layout data to the terminal device; and wherein the terminal device comprises a request sending means that sends the request for the page data, a layout data storing means that stores the layout data received from the intermediate processing device, a drawing data generating means that determines the page layout based on the page layout data and generates drawing data configured to display the page in accordance with the determined layout, and a displaying means that displays the page in accordance with the drawing data.

### TECHNICAL FIELD

The present invention relates to a network system which includes a terminal device, which requests a page from an Web server, and an intermediate processing device, which receives page data from the Web server, processes the page data, and sends the processed page data to the terminal device.

### BACKGROUND OF THE INVENTION

With the rapid spread of computer networks, represented by the internet, and development of their technology, a user can browse information on a network not only through a desktop-type or laptop-type PC (Personal Computer) but also through various devices including a mobile phone, a PDA (Personal Digital Assistance), a home appliance, and an automotive navigation system. Information browsing software (hereinafter referred to as “browser”) is embedded in these devices. A browser analyzes, for example, information on a network (for example, page data such as a document described in a markup language, e.g., an HTML (Hyper, Text Markup Language)). Next, based on the result of the analysis, the browser generates and performs rendering. And by using the drawing data obtained by the rendering, the browser performs drawing processing and lets a screen of the terminal device display the corresponding page.

Meanwhile, there is a type of a browser, which cooperates with a server to display a page. For example, Japanese Patent Provisional Publication No. HEI 11-15819A (hereinafter referred to as “patent document 1”) and Japanese Patent Provisional Publication No. 2000-57044A (hereinafter referred to as “patent document 2”) disclose systems that include servers and browsers to perform such a behavior. In the systems described in these patent documents, the server bears a part of the function of the browser (generation of intermediate codes, to be specific) and a speed up of the speed of displaying a page on the browser is realized.

In this specification, the meanings of “page”, “layout data”, “drawing data” are defined below.
“page”: The page means the information to be displayed based on a group of data retrieved through a network, and is all of the contents that are to be displayed when the user designates a corresponding URI (Uniform Resource Identifier). Specifically, the page refers, for example, to all of the contents that can be displayed by scrolling an image on a screen. Here, the page includes not only a page that is browsed online, but also a page that is browsed offline. The page that is browsed offline includes, for example, a page that has been retrieved through a network and cached by a browser, or a page that has been stored in a terminal in mht format. The page includes an HTML document, an image file, and various types of data (page data) such as music data.
“layout data”: The layout data means data in binary form including a layout tree, an ID for each element and coordinates that are obtained by a page-maker function of a browser, and does not depend on a screen size or an aspect ratio of a screen. Here, the size of the screen means the number of pixels on the screen such as WQVGA (Wide Quarter Video Graphics Array) or VGA (Quarter Video Graphics Array).
“drawing data”: The drawing data means data for displaying on a screen, obtained by performing rendering, which corresponds to the screen size or the aspect ratio of the screen, based on a layout data.

However, the intermediate code in the systems described in the above patent documents 1 and 2 is made by merely compressing HTML data based on a predetermined rule. Therefore, the advantage of these systems is only that the size of the data to be processed by the browser is reduced, and the browser, eventually, has to perform processes such as analyzing the intermediate code, rendering, or expansion of the drawing data. Consequently, the burden on the browser (terminal device) is hardly reduced in substance.

As a method of reducing a burden on the terminal device, for example, it can be considered to let the server share the most of the parts of the terminal device's function. For example, if the server shares the range of process from a process of analyzing an HTML data to a process of generating drawing data, then, on the terminal side, it is possible to display a page only by processing the drawing data received from the server. It is especially beneficial, for example, for a wireless terminal, such as a mobile telephone, in which available resources are limited, to reduce greatly the burden on the terminal side.

However, the inventor of the present application has been found that if the server shares the most parts of the processes as described above, then it might generate various problems. For example, when a user wants to change the layout of the page, the terminal device has to communicate with the server each time a layout change event occurs. Also, for an extreme example, a wireless terminal, such as a mobile telephone, cannot change its layout at a place where radio waves do not reach, since it cannot access a network. In addition, it is necessary for a browser to update all of the page by retrieving newly the drawing data for all of the page, even if the page is to be updated only in a small part. Therefore, there is a problem in which a function to dynamically update a part of the screen, such as Ajax (Asynchronous JavaScript+XML) or SMIL (Synchronized Multimedia Integration Language), cannot be realized. In this case, since a target to be updated ranges all of the page, the amount of data to be communicated and the amount of data to be processed increase. Consequently, problems such as a problem in which the time for updating the page drawing is elongated, or a problem in which a user has to pay an unnecessary communication fee, for example, arise.

### DISCLOSURE OF THE INVENTION

As described above, the inventor of the present application has found that if the server shares the most of the parts of the browser function, merely to reduce the burden on the terminal device, then the usability of the terminal is seriously decreased. The present invention has been accomplished in view of the aforementioned circumstances and it is intended to provide a network system which reduces a burden on a terminal device while maintaining usability of a browser.

According to an embodiment of the invention, there is provided a network system comprising: a terminal device that sends a request for page data for displaying a page; an Web server that sends the page data in response to the request; and an intermediate processing device that processes the page data received from the Web server and for sending the processed data to the terminal device. The Web server has a page data storing means that stores the page data, and sends the page data, corresponding to the request, to the intermediate processing device responding to the request from the terminal device. The intermediate processing device comprises a page layout analyzing means that analyzes the page data received from the Web server, and a layout data generating means that generates layout data which is to be the basis of the layout of the page, and the intermediate processing device sends the generated layout data to the terminal device. The terminal device comprises a request sending means that sends the request for the page data, a layout data storing means that stores the layout data received from the intermediate processing device, a drawing data generating means that determines the page layout based on the layout data and generates drawing data for displaying the page in accordance with the determined page layout, and a displaying means that displays the page in accordance with the drawing data.

With this configuration, the terminal device, for example, can perform a layout change in the offline state, and display an Ajax page or a SMIL page, properly. And, along with this, the intermediate processing device performs processes for analyzing a page and generating page layout data, so that the burden on the terminal device is reduced. That is, according to an embodiment of the invention, a network system, which reduces the burden on the terminal device while maintaining the usability of the browser, is realized.

The terminal device may further include an input means that accepts an input operation by a user, wherein the drawing data generating means may update the drawing data by changing the page layout, which is currently displayed, so that the display of the page conforms to at least one of a size or an aspect ratio of a screen of the displaying means, when the input means is operated to change the page layout.

The intermediate processing device further comprises: a request sending means that sends a request, when a predetermined event arises, corresponding to the event to the Web server, if the page which is currently displayed on the displaying means is a page configured such that a part of the page is to be dynamically updated in response to the predetermined event; a response retrieving means that retrieves a predetermined response in response to the request from the Web server; and a difference data generating means that generates difference data of the layout data based on the retrieved response. The intermediate processing device sends the generated difference data to the terminal device, and the drawing data generating means of the terminal device changes the layout being displayed on the displaying means and updates the drawing data based on the received difference data.

The predetermined event may be the event in which the intermediate processing device receives a signal, which corresponds to the operation of the input means concerning the part of the page which is dynamically updated, from the terminal device.

The intermediate processing unit may further include a time measuring means that measures time, wherein the predetermined event is such that the intermediate processing device determines the timing for executing scripts, which are included in the page data, based on the time measuring means.

The layout data may include a layout tree for the page, an ID for each element, and coordinates.

According to the embodiment of the invention, it is possible to provide a network system which reduces the burden on the terminal while maintaining the usability of the browser.

### BRIEF DESCRIPTION OF THE DRAWINGS

FIG. 1 is a diagrammatical view illustrating a configuration of a network system according to an embodiment of the invention.

FIG. 2 is an outline block diagram illustrating a configuration of a terminal device according to the embodiment of the invention.

FIG. 3 is a state transition diagram explaining processes executed in the network system according to the embodiment of the invention.

FIG. 4 is a block diagram illustrating a configuration of an Web server according to the embodiment of the invention.

FIG. 5 is a block diagram illustrating a configuration of a proxy server according to the embodiment of the invention.

FIG. 6 is a functional block diagram of a browser core unit of the proxy server according to the embodiment of the invention.

FIG. 7A illustrates an example of a screen displayed by the browser according to the embodiment of the invention.

FIG. 7B illustrates an example of a screen displayed by the browser according to the embodiment of the invention.

FIG. 8A illustrates an example of a screen displayed by the browser according to the embodiment of the invention.

FIG. 8B illustrates an example of a screen displayed by the browser according to the embodiment of the invention.

### BEST MODE FOR CARRYING OUT THE INVENTION

In the following, an embodiment according to the present invention is described with reference to the accompanying drawings. In addition, hereinafter, “step” is abbreviated as “S” in the descriptions and the figures below.

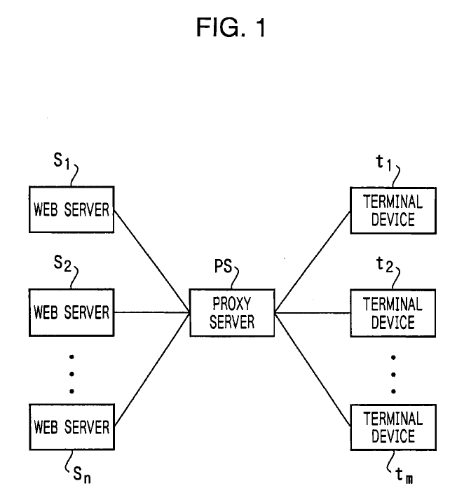

FIG. 1 illustrates a configuration of a network system according to an embodiment of the invention. The network system according to the embodiment of the invention includes a plurality of Web servers S₁-Sₙ, a proxy server PS, and a plurality of terminal devices t₁-tₘ. Each server and each terminal device are mutually connected through a TCP/IP-based network. Each server and each terminal device are configured to perform as a WWW (World Wide Web) server and a WWW client, respectively.

The Web servers S₁-Sₙ are storage devices for storing page data to be provided to WWW clients. The proxy server PS is an intermediate processing device that includes a function to relay communications among the terminal devices t₁-tₘ and the Web servers S₁-Sₙ, and a function to execute processes to enable browsing of pages provided by the Web servers S₁-Sₙ at every terminals t₁-tₘ. In addition, the proxy server PS includes a function to cooperate with the terminal devices t₁-tₘ to execute predetermined processes to browse pages provided by the Web servers S₁-Sₙ. Browsers are embedded in the terminal devices t₁-tₘ. Further, in the embodiment of the invention, the terminal devices t₁-tₘ are mobile telephones. However, in another embodiment of the invention, the terminal devices t₁-tₘ can be, for example, desktop-type or laptop-type PCs, PDAs, PHSs (Personal Handy phone Systems), or various types of portable electronic devices with communication functions, such as portable game devices.

Furthermore, in the embodiment of the invention, the Web servers S₁-Sₙ are different only in the point that they have different page data to deliver. From the viewpoint of configuration, the Web servers S₁-Sₙ, are substantially the same. In addition, in the embodiment of the invention, the terminal devices t₁-tₘ are different only in the point that their users are different. From the viewpoint of configuration, the terminal devices t₁-tₘ are substantially the same. Hereinafter, to avoid overlap of explanations, as a representative, the processes of the Web server S₁ and the terminal device t₁ are explained. Explanations for other Web servers S₂-Sₙ and other terminal devices t₂-tₘ are omitted.

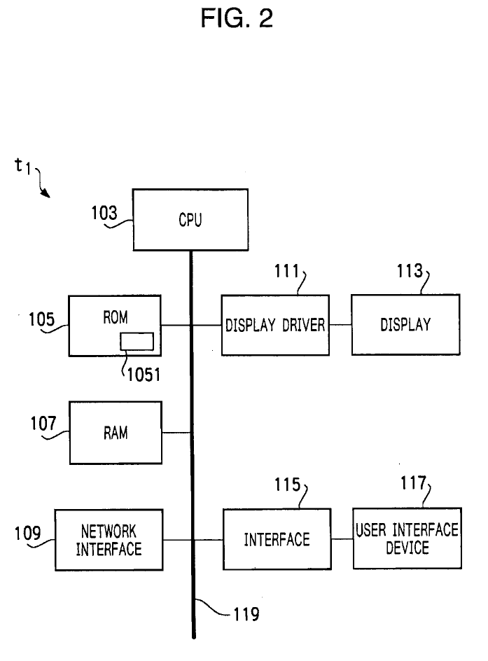

FIG. 2 is a block diagram illustrating a configuration of a terminal device according to the embodiment of the invention. As shown in FIG. 2, the terminal device t₁ has a CPU (Central Processing Unit) 103 to integrally control the entirety of the device. Every component is connected to the CPU 103 through a bus 119. These components include a ROM (Read-Only Memory) 105, a RAM (Random-Access Memory) 107, a network interface 109, a display driver 111, and an interface 115, etc. A display 113 and a user interface device 117 are connected to the CPU through the display driver 111 and the interface 115, respectively.

The ROM 105 has stored various programs and data. A browser 1051, for example, is a program that has been stored in the ROM 105. The browser 1051 is information browsing software for displaying a page on the display 113, based on rendering data obtained online or offline.

The RAM 107 stores program data, etc., which is used by the CPU, temporarily. For example, after the CPU 103 has read out, in accordance with a user operation using the user interface 117 (hereinafter, simply written as “user operation”), a program (a browser, for example) stored in the ROM 105, the CPU 103 loads the program into a predetermined area on the RAM 107 and executes the program. Following this, the browser 1051 is activated.

Here, the user interface device 117 includes a five-way key and a function key. The five-way key includes four directional keys and one enter key. When the user pushes these keys, the mobile device t₁ performs to realize a predetermined function corresponding to the key pushed.

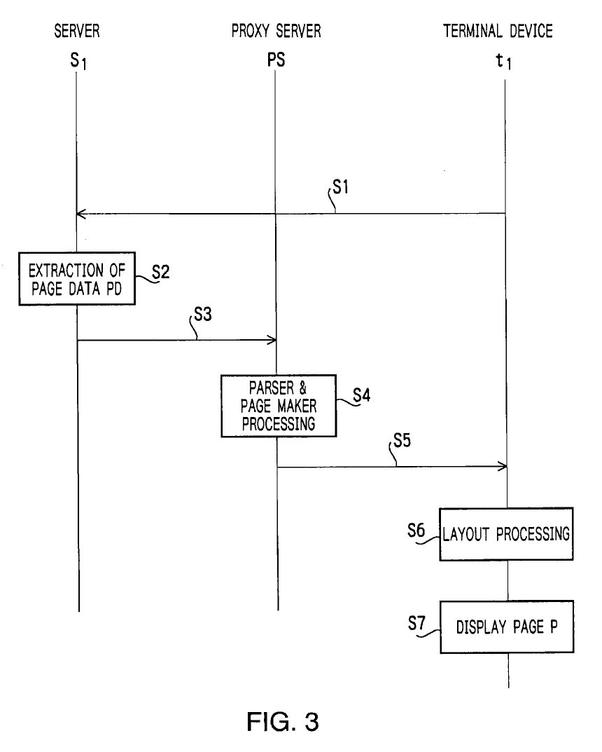

Here, FIG. 3 shows a flow of processes executed by the network system according to the embodiment of the present invention. When a URI is designated by inputting a URI through a user operation or by selecting one of anchor tags that are included in a page P which is currently displayed on the display 113, for example, the browser 1051 sends a request RQ, which is a message for requesting to retrieve a page indicated by the designated URI (the Web server S₁, for example), to the Web server S₁ (S1) through a network interface 100. The request RQ may be relayed by the proxy server PS, or may be sent directly to the Web server S₁.

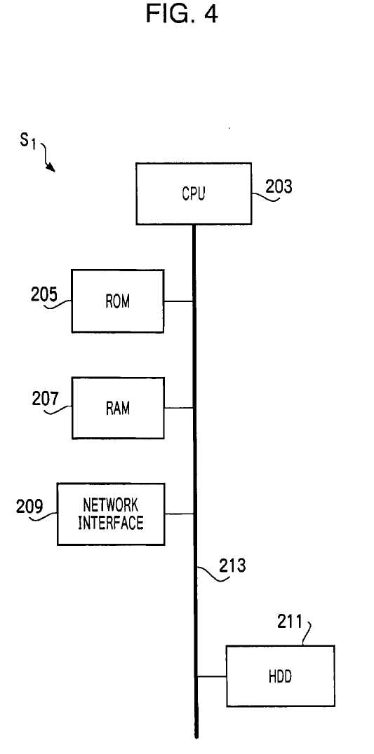

FIG. 4 is a block diagram illustrating a configuration of the Web server S₁. The Web server S₁ includes a CPU 203 which integrally controls the entirety of the Web server S₁. Every component is connected to the CPU 203 through a bus 213. These components include a ROM 205, a RAM 207, a network interface 209, and an HDD (Hard Disk Drive) 211.

The ROM 205 stores various programs and data for executing processes corresponding to a request from a client. These programs are resident, for example, in the RAM 207 of the Web server S₁. That is, the Web server S₁ keeps monitoring whether there exists a request from a client or not. And, if there exists a request, then the Web server SI executes processes corresponding to the request immediately.

The HDD 211 stores page data to be provided to the terminal devices t₂-tₘ. When the Web server S₁ receives a request RQ from the terminal devices t₂-tₘ, then the Web server S₁ searches the HDD 211 and retrieves page data PD corresponding to the request (S2). And, as a response to the requests RQ, the Web server S₁ sends corresponding page data PD to the terminal device t₁ (S3). According to the embodiment of the invention, the response is relayed by the proxy server PS, and sent to the terminal device t₁.

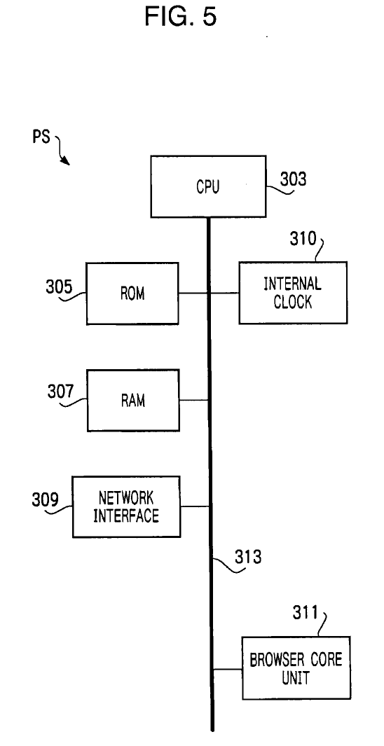

FIG. 5 is a block diagram illustrating a configuration of the proxy server PS. The proxy server PS includes a CPU 303 which integrally controls the entirety of the proxy server PS. Every component is connected to the CPU 303 through a bus 313. These components include a ROM 305, a RAM 307, a network interface 309, and a browser core unit 311.

The ROM 305 stores programs and data to realize various functions. These programs are loaded and are resident, for example, in the RAM 307. Therefore, when the proxy server PS receives a signal from an external terminal, then the proxy server PS can execute the corresponding processes immediately. For example, when the proxy server PS receives the above response from the Web server S1, then the browser core unit 311 applies predetermined processes described below to the page data PD (S4).

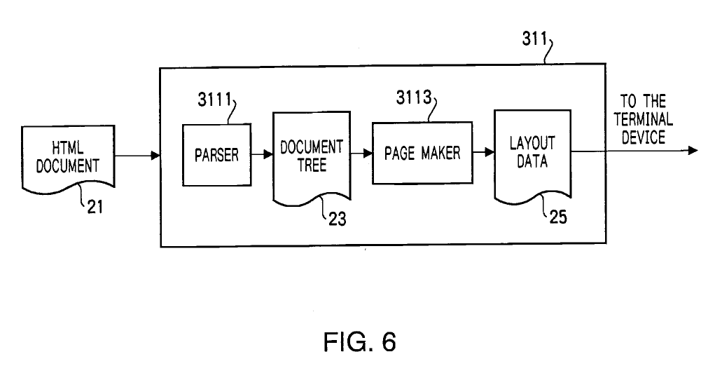

FIG. 6 is a functional block diagram illustrating the predetermined processes executed by the browser core unit 311. As shown in FIG. 6, the browser core unit 311 includes functional diagrams corresponding to a parser 3111 and a page maker 3113, respectively.

The parser 3111 analyzes an HTML document 21 contained in the page data PD and generates a document tree 23 which expresses components of the HTML document 21 in terms of a tree structure. However, the document tree 23 expresses only logical structure of the HTML document 21, and it does not include information about expression forms.

Next, the page maker 3113 generates layout data 25, based on information about the document tree 23, tags, and style sheets, and stores the layout data 25 in the RAM 307. As described above, the layout data 25 is binary data, and it includes a layout tree, an ID for each element, and coordinates. Further, the layout tree is generated based on information about the document tree 23, tags, style sheets, and it includes an expression form of the HTML document, such as a block, an inline, a table, a list, and an item, for example. Furthermore, the layout tree expresses in which order elements such as a block, an inline, and a table are arranged. However, the layout tree does not include information such as information about where on the screen of the terminal these elements are displayed and with which width and height these elements are displayed, or information about from which part a character is folded.

Further, the proxy server PS generates, like a browser for a PC, standard layout data which does not depend on a specification of the terminal device (the size of the screen on the display or the aspect ratio, for example) that displays the page. Namely, the proxy server PS generates the layout data 25 with generality by executing transcoding processes which do not depend on a client. The proxy server PS does not execute transcoding processes which depend on implementation of client side, such as a transcoding process in which a browser for a PC and a browser for a mobile telephone are distinguished, for example.

The proxy server PS sends the layout data 25 generated by the browser core unit 311 to the terminal device t₁ as a response to the request RQ (S5).

After receiving the layout data 25, the terminal device t₁ stores the layout data 25 in the RAM 107. The browser 1051 executes layout processes based on the layout data 15 (S6), and lets the display 113 indicate the page P of the Web server S₁. Specifically, at the process of S6, a formatter function of the browser 1051 determines a layout (folding back of characters in accordance with the number of pixels in the width direction of the screen; position, width, and height of each element on the screen; for example), based on the information about the layout tree in the layout data 25 and the information about the specification of the terminal device t₁ (the size of the screen on the display 113 or the aspect ratio, for example). Next, the browser 1051 executes rendering based on the determined layout, and generates drawing data. And, at the process of S7, the browser 1051 loads the generated drawing data into a video memory area in the RAM 107, and lets the display 113 indicate the page P of the Web server S₁. In addition, like a browser for a PC, the browser 1051 may executes rendering in which folding back of characters is not taken into account. In this case, the browser 1051 is in a displaying configuration in which the browser 1051 is scrollable in the width direction of the screen. An element with a coordinate value which is greater than the number of pixels in the width direction of the screen can be browsed by scrolling the page P in the width direction of the screen.

As described above, in the network system according to the embodiment of the invention, the proxy server PS shares the range of processes from the process of analyzing an HTML document to the process of generating layout data, and the remaining processes are executed in the terminal device's side. With this configuration, various problems described above can be resolved, and a network system, in which a burden on a terminal device side is reduced while maintaining usability of a browser, is realized.

In a network system according to the embodiment of the invention, when a user operation, such as changing the layout of the currently displayed page, for example, is performed, the browser 1051 determines a new layout based on the layout data stored in the RAM 107, and executes rendering processes and processes for indicating to the display 113. Namely, with a network system according to the embodiment of the invention, the browser 1051 can executes a layout change of a page in offline mode. In other words, the browser 1051 can perform a layout change without communicating with a server (the Web server SI or the proxy server PS). Thus, in this case, the processing speed for a layout change is faster and the communication fee is reduced, in comparison with the case in which the layout is changed by sending a request to a server. Here, a layout change means a change of a layout such that the layout is optimized with or conforms to the size or the aspect ratio of the screen, and does not mean a simple change of the layout, such as changing the font size, for example.

Further, there exists a terminal device in which the orientation of the screen with respect to the main body of the device can be changed by rotating the display with respect to the main body of the device in a plane. In such a terminal device, when the display is rotated in 90 degrees, then the aspect ratio changes (from 4:3 to 3:4, for example), and consequently, the optimum layout of the page changes. In a system with a configuration such that a layout is changed by sending a request to a server, in order that the page is always displayed with the optimum layout corresponding to the aspect ratio, the terminal must communicate with the server to get the drawing data each time the orientation of the screen is changed, hence there exists a disadvantage such that time and communication cost has to be spent for each layout change. In contrast, in the embodiment of the invention, as explained above, the processes required for a layout change of a page can be executed within the terminal device. It is extremely advantageous with respect to processing time and communication cost.

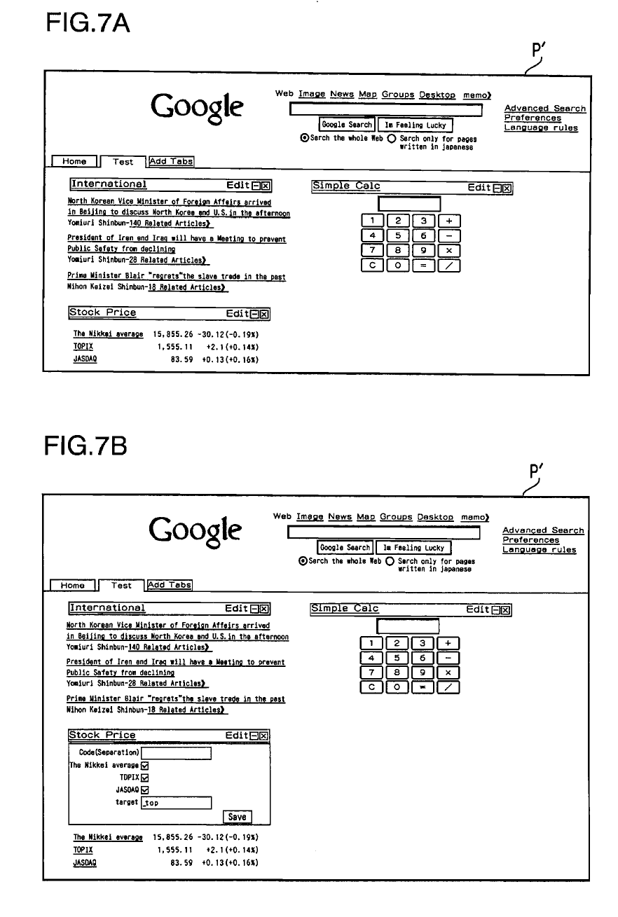

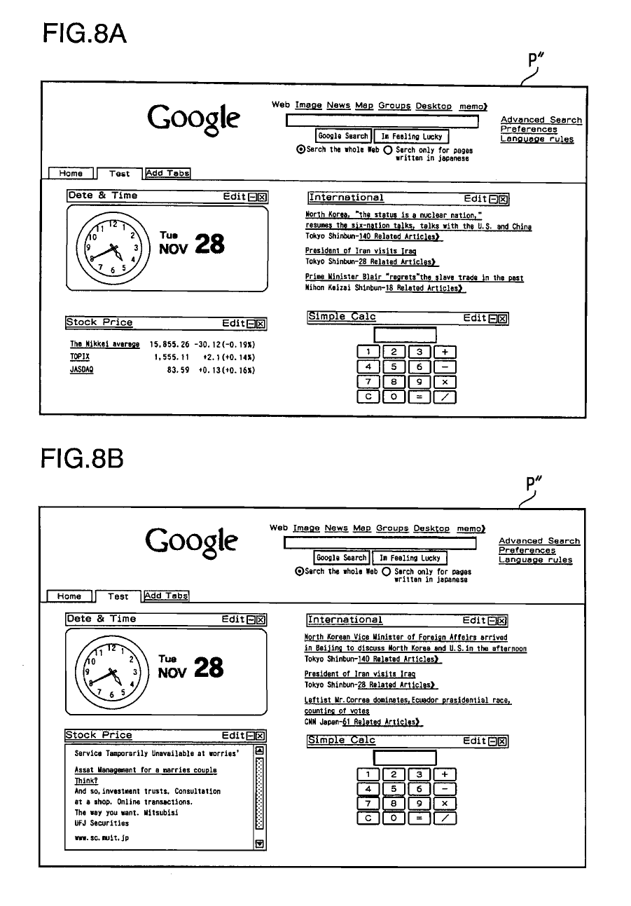

Further, for example, in a network system according to the embodiment of the invention, the browser 1051 can be adapted for Ajax or SMIL. Hereinafter, behavior of the browser 1051 caused by Ajax is explained with reference to FIGS. 7 and 8.

FIGS. 7A and 7B illustrate examples of screens displaying the page P′ of a portal site using Ajax (the page of the Web server S₂, for example). The page P includes “International,” “Stock Prices,” and “Simple Calc”, as it's contents. While displaying the page P′, the browser communicates asynchronously with the Web server S₂ through the proxy server PS. In the explanation below, it is assumed that the proxy server PS has already executed the processes corresponding to the page P′ (the range of processes from the process of analyzing the HTML document to the process of generating the layout data), and that the page P′ has already been displayed on the browser 1051.

In the state of FIG. 7A, when “Edit” of the “Stock Price,” for example, is selected through a user operation, the browser 1051 sends a notice of the key event to the proxy server PS. After receiving the notice, the proxy server PS loads a script corresponding to the “Edit” which is described in an HTML document corresponding to the page data which has already been retrieved. By executing this script, a part of the configuration or contents of the page can be modified through processing a DOM (Document Object Model), and in addition, it is possible to send an XMLHttpRequest, which is explained later, to the Web server. Here, the proxy server PS, as described above, executes the range of processes from the process of analyzing the HTML by the browser core unit 311 to the process of generating layout data. Therefore, the proxy server PS recognizes the status of the screen on the browser 1051.

When an event of a user operation with respect to the “Edit” arises, the browser 1051 sends the contents of the event to the proxy server PS. Next, the proxy server PS executes scripts corresponding to the contents of the event, and sends the information as an XMLHttpRequest to the Web server S₂. The Web server S₂ executes the processes corresponding to the XMLHttpRequest, and generates data in which the result is expressed in XML (Extensible Markup Language) (hereinafter referred to as “operation result data”), and sends it to the proxy server PS. Additionally, the operation result data can be data which is described in JSON (JavaScript Object Notation), for example.

The proxy server PS partially updates the DOM data based on the layout data that has already been retrieved and the operation result data. Then the proxy server PS sends the layout data with respect to the updated DOM elements to the browser 1051 as difference data of the layout data for the page P′. In addition, the proxy server PS associates the difference data with the layout data which has already been retrieved, and stores the difference data. The proxy server PS recognizes the status of the screen on the browser 1051 based on the difference data and the layout data. Here, the difference data is the layout data with respect to the updated DOM elements as described above. For example, the difference data is the data expressing the contents of the change of the layout of the page P′, which arises before and after “some user operation with respect to the “Edit”,” as described above. And the difference data includes the layout tree reflecting the change, IDs of the updated elements, and coordinates of the updated elements.

The browser 1051 associates the received difference data with the corresponding layout data stored in the ROM 107, and stores the received difference data. Then, the browser 1051 reattempts the layout process based on the difference data, performs, once again, rendering of only a part of the page, generates new drawing data, and lets the display 113 indicate the page P′. As a result, as shown in FIG. 7B, a part of the page P′ is updated and displayed on the browser 1051.

FIGS. 8A and 8B illustrate examples of the page P″ of a portal site using Ajax (the page of the Web server S₃, for example), and include “Date & Time,” “International,” “Stock Price,” and “Simple Calc.” Here, for each of the contents the “Date & Time,” the “International,” and the “Stock Price,” the scripts have been described so as to retrieve information on update, periodically from the Web server S₃. While displaying the page P″, the browser 1051 communicates with the Web server S₃ asymmetrically through the proxy server PS. In the explanation below, similarly to the embodiment shown in FIG. 7, it is assumed that the proxy server PS has already executed the processes corresponding to the page P″ (the range of processes from the process of analyzing the HTML document to the process of generating layout data), and that the page P″ has already been displayed on the browser 1051 (the state shown in FIG. 8A).

The proxy server PS, similarly to the embodiment shown in FIG. 7, recognizes the status of the screen on the browser 1051, refers to an internal clock 310 and monitors the timing to execute scripts for the “Date & Time,” the “International,” and the “Stock Price.” And, when the proxy server PS determines that it is the timing, the proxy server PS executes the above scripts. The proxy server PS sends the information, which is retrieved by executing the above scripts, to the Web server S₃ as an XMLHttpRequest. The Web server S₃ executes the processes corresponding to the XMLHttpRequest, gets the operation result data and sends it to the proxy server PS.

The proxy server PS generates the difference data of the layout data for the page P″ based on the layout data which has already been retrieved and the operation result data, and sends the difference data to the browser 1051. In addition, the proxy server PS associates the above difference data with the layout data which has been retrieved, and stores the above difference data. The proxy server PS recognizes the status of the screen on the browser 1051 based on the difference data and the layout data.

The browser 1051 associates the received difference data with the layout data which has been stored in the ROM 107, and stores the received difference data. And, the browser 1051 reattempts the layout process based on the difference data, performs, once again, rendering of only a part of the page, generates new drawing data, and lets the display 113 indicate the page P″. As a result, as shown in FIG. 8B, a part of the page P″ is updated and displayed on the browser 1051.

As described above, in a network system according to the embodiment of the present invention, it is possible to perform rendering using the data corresponding to the updated part on the terminal device's side. Therefore, it is possible to update a part of the page without performing a transition to update all of the page which is indicated on the display 113. Namely, by the network system according to the embodiment of the invention, it is possible to display a page which is enhanced in responsiveness by dynamically rewriting a part of DOM elements, such as Ajax or SMIL.

In the network system according to the embodiment of the invention, as described above, the proxy server PS executes the range of processes from the process of analyzing an HTML document to the process of generating a layout data. In these processes, processes such as resizing an image, deletion, and JavaScript, for example, are executed. Thus, the amount of the data traffic transmitted from the proxy server PS to the terminal device t₁ is reduced. As a result, a user can enjoy benefits, such as an increase in speed of displaying a page, for example. In addition, a carrier can enjoy a benefit that the risk of increases in traffic is reduced.

Further, in a conventional system in which a parser function and a page maker function are performed by a browser which is implemented in a terminal device, in order to display a page in which a latest CSS (Cascading Style Sheets) are utilized, it is necessary that the browser, which is implemented in the terminal device, adapts to the latest CSS. On the other hand, in a network system according to the embodiment of the invention, if the browser core unit 311 of the proxy server PS has adapted to the latest CSS, then the CSS can be analyzed on the proxy server PS's side. Therefore, a page, in which the latest CSS are utilized, can be properly displayed, even if the browser 1051 of the terminal device does not adapt to the latest CSS.

Furthermore, a majority of browsers for mobile telephones are out of consideration of version upgrades. Therefore, it is practically difficult for mobile telephones to adapt to the latest version of the CSS, for example, to which extensions and corrections are continually added. Moreover, it is difficult for mobile telephones to adapt to version upgrades of various plug-ins (Flash (registered trademark), for example). However, in a network system according to the embodiment of the invention, mobile telephones can adapt to a page in which the latest CSS or application files are utilized, by upgrading the browser core unit 311 of the proxy server PS. Therefore, an advantageous effect, such that even if the browser of a terminal cannot be upgraded, the terminal can always properly display a page which is made by using the state-of-the-art technology, is obtained.

That is to say, in the network system according to the embodiment of the present invention, every browser in the system can enjoy benefit of function enhancement of the proxy server PS.

In addition, in the network system according to the embodiment of the invention, a page which can be displayed by a terminal device does not depend on the browser which is implemented in the terminal device. For example, by implementing a layout engine, which is widely adopted for PCs, etc., in the browser core unit 311 of the proxy server PS, it is possible to browse pages, similarly to the PC environment, with a mobile device such as a PDA or a mobile phone. As a result, there is no need for a web master to consider various browsers that conform to different specifications, when the web master produces a page. On the other hand, an end user can browse a page, which is supposed to be browsed in the PC environment, with a mobile telephone. Therefore, problems caused by restrictions on functions of a browser dedicated for a mobile phone, such as a problem in which a page is displayed abnormally, for example, are resolved.

Additionally, in a network system according to the embodiment of the invention, as described above, since the proxy server PS executes the range of processes from the process of analyzing an HTML document to the process of generating a layout data, it is possible to reduce resources used in a terminal device (the load on the CPU, the capacities of the ROM, and the RAM, for example) and simplify the implementation of the browser. Consequently, it is possible to avoid introducing higher functionalities into the terminal device and the cost for the terminal device can be suppressed.

Furthermore, by restricting the functionalities on the terminal device's side and letting the proxy server PS share the burden of function enhancement, such as following up of the latest specification, it can be said that the state of the software on the terminal device's side (the browser, in this case) is always conforming to the latest specification, and it is possible to extend the life span of the software. At the same time, by preventing the functionalities on the terminal device's side from becoming complex, the risk of occurrence of problems is reduced, and this leads to the improvement of quality.

A conventional idea for reducing the load on the client's side has been to let the server's side share as much functions of the browser as possible, and to reduce resource on the client. However, in a network system according to the embodiment of the invention, contrary to such an idea, the formatter function is intentionally left on the client's side and executed. In this manner, both reduction of the load on the client's side and enhancement of user's benefit are realized.

The embodiment according to the invention has been described above. The present invention is not limited to these embodiments, and it can be modified in various ranges.

Incidentally, Java and other brands include Java in the description of the present application are trademarks or registered trademarks of Sun Microsystems, Inc. in the United States.

1. A network system, comprising:
a terminal device that sends a request for page data for displaying a page to a Web server;
the Web server that sends the page data in response to the request; and
an intermediate processing device that processes the page data received from the Web server and sends the processed page data to the terminal device;
wherein the Web server comprises a page data storing unit that stores the page data, and the Web server sends the page data, corresponding to the request, to the intermediate processing device in response to the request from the terminal device;
wherein the intermediate processing device comprises:
a page analyzing unit that analyzes the page data received from the Web server; and
a layout data generating unit that generates layout data to be utilized as a basis for a page layout, based on a result of an analysis by the page analyzing unit,
wherein the intermediate processing device sends the generated layout data to the terminal device; and
wherein the terminal device comprises:
a request sending unit that sends the request for the page data;
a layout data storing unit that stores the layout data received from the intermediate processing device;
a drawing data generating unit that determines the page layout based on the page layout data and generates drawing data for displaying the page in accordance with the determined layout; and
a displaying unit that displays the page in accordance with the drawing data.

2. The network system according to claim 1,
wherein the terminal device further comprises an input unit that accepts an input from a user; and
wherein the drawing data generating unit changes the page layout which is currently displayed and updates the drawing data so that the display of the page conforms to at least one of a size of a screen of the displaying unit or an aspect ratio of the screen of the displaying unit, based on the layout data stored in the layout data storing unit, when the input unit is operated so as to change the page layout.

3. The network system according to claim 2,
wherein the intermediate processing device further comprises:
a request sending unit that sends a request, when a predetermined event arises, corresponding to the event to the Web server, if the page which is currently displayed on the displaying unit is a page configured such that a part of the page is to be dynamically updated in response to the predetermined event;
a response retrieving unit that retrieves a predetermined response in response to the request from the Web server; and
a difference data generating unit that generates difference data of the layout data based on the retrieved response,
wherein the intermediate processing device sends the generated difference data to the terminal device, and the drawing data generating unit of the terminal device changes the layout being displayed on the displaying unit and updates the drawing data based on the received difference data.

4. The network system according to claim 3, wherein the predetermined event is that the intermediate processing device receives a signal corresponding to an operation of the input unit, with respect to a portion of the page which is to be dynamically updated, from the terminal device.

5. The network system according to claim 3, wherein the intermediate processing device further comprises a time measuring unit that measures time, and wherein the predetermined event is that the intermediate processing device determines timing for executing scripts contained in the page data based on the time measuring unit.

6. The network system according to claim 1, wherein the layout data includes a layout tree of the page, and an ID and a coordinate for each element of the page.

7. An intermediate processing device configured to process page data received from a Web server and send the processed data to a terminal device, comprising:
a page analyzing unit that analyzes the page data; and
a layout data generating unit that generates layout data which is to be utilized as a basis for a layout of the page, based on a result of an analysis by the page analyzing unit;
wherein the intermediate processing device sends the layout data to the terminal device.

8. The intermediate processing device according to claim 7,
further comprising:
a request sending unit that sends a request, when a predetermined event arises, corresponding to the event to the Web server;
a response retrieving unit that retrieves a predetermined response corresponding to the request from the Web server; and
a difference data generating unit that generates difference data of the layout data based on the retrieved response;
wherein the intermediate processing device enables the terminal device to dynamically update a part of the page which is currently displayed on the terminal device, in response to the predetermined event, by sending the generated difference data to the terminal device.

9. The intermediate processing device according to claim 8, wherein the predetermined event is that the intermediate processing device receives a predetermined signal from the terminal device.

10. The intermediate processing device according to claim 8, further comprising a time measuring unit that measures time,
wherein the predetermined event is that the intermediate processing device determines timing for executing scripts contained in the page data, based on the time measuring unit.

11. The intermediate processing device according to claim 7, wherein the layout data includes a layout tree of the page, and an ID and a coordinate for each element of the page.

12. A terminal device, comprising:
a sending unit that sends a request for page data configured to display a page to a Web server;
a receiving unit that receives layout data to be utilized as a basis for a page layout, generated by an intermediate processing device based on the page data;
a layout data storing unit that stores the received layout data;
a drawing data generating unit that determines the page layout based on the layout data and generates drawing data for displaying the page in accordance with the determined layout; and
a displaying unit that displays the page by utilizing the drawing data.

13. The terminal device according to claim 12, further comprising:
an input unit that accepts an input from a user,
wherein the drawing data generating unit changes the page layout which is currently displayed and updates the drawing data so that the display of the page conforms to at least one of a size of a screen of the displaying unit or an aspect ratio of the screen of the displaying unit, based on the layout data stored in the layout data storing unit, when the input unit is operated so as to change the page layout.

14. The terminal device according to claim 13, wherein the receiving unit receives difference data of the layout data from the intermediate processing device, and the drawing data generating unit changes the layout which is currently displayed and updates the drawing data based on the received difference data, if the page currently displayed on the displaying unit is a page such that a part of the page is to be dynamically updated in response to a predetermined event.

15. The terminal device according to claim 14, wherein the predetermined event is an operation which is related to the portion of the page that is dynamically updated and accepted by the input unit, and the sending unit sends a signal corresponding to the operation to the intermediate processing device.

16. The terminal device according to claim 12, wherein the layout data includes a layout tree of the page data, and an ID and a coordinate of each element of the page.
